(19) United States
(12) Patent Application Publication
(10) Pub. No.: US 2022/0234116 A1
(43) Pub. Date: Jul. 28, 2022

(54) PROCESSING TOOL AND PROCESSING TOOL ASSEMBLY

(71) Applicant: JUI-PENG LIN, Taichung City (TW)

(72) Inventor: JUI-PENG LIN, Taichung City (TW)

(21) Appl. No.: 17/160,781

(22) Filed: Jan. 28, 2021

(51) Int. Cl. B23B 29/04

(52) U.S. Cl. CPC B23B 29/043; B23B 2260/072; B23B 2260/03

(57) ABSTRACT

A processing tool includes a long cutting portion with a connecting surface and at least one clamped portion which is fixed to the connecting surface. The long cutting portion extends along a longitudinal direction. Each of two sides of the long cutting portion along the longitudinal direction is an abutted end. A bottom portion of each of the abutted ends is connected to the connecting surface, and a top portion of each of the abutted end is away from the connecting surface. A first length is defined between the top portions of the abutted ends, and a second length is defined between the bottom portions of the abutted ends, wherein the first length is smaller than the second length. A processing tool assembly is provided as well. With such design, the processing tool thereof could be changed easily. Multiple workpieces could be simultaneously cut, and the accuracy thereof could be enhanced.

### BACKGROUND OF THE INVENTION

### Technical Field

The present invention relates generally to a processing tool and a processing tool assembly, and more particularly to a processing tool and a processing tool assembly, wherein the processing tool of the processing tool assembly could be changed easily; multiple workpieces could be processed simultaneously by the processing tool assembly; the processing tool assembly could precisely perform processing.

### Description of Related Art

In industrial manufacture, metal processing is applied to manufacture hand tools, transmission components, or precision components. Metal processing primarily utilizes a machine tool to perform processing steps. The machine tool is widely used in the industry, wherein an operation of the machine tool is clamping a workpiece to fix the workpiece on a fixing frame of the machine tool and making the workpiece move relative to the processing tool. By doing this, a surface or a middle portion of the workpiece could be cut, polished, ground, or treated with other motions. So far, the processing could be performed by the machine tool includes facing, centering, drilling holes, boring, reaming, knurling, thread cutting, taper pin cutting, and so on.

Taking the wrench processing as an example, a processing method performed by a conventional broaching machine is described below. FIG. 1 is a top view of a conventional external broach 10 and a fixing seat 15 for processing a wrench W, wherein align a mouth C of the wrench W to a cutting portion 11 of the external broach 10. Generally, the external broach 10 is fixed to fixing seat 15 by inserting an engaged portion 12 of the external broach 10 from an end of the long groove 151 and through a long groove 151 of the fixing seat 15 and then screwing the external broach 10. Then, operate the broaching machine tool to cut the mouth C of the wrench W.

Since the conventional external broach 10 should be disengaged from the end of the long groove 151 of the fixing seat 15, the disengagement of the conventional external broach 10 is restricted, unless a sufficient operating space (which means a length of the external broach 10 plus a length of the fixing seat 15) is provided. Therefore, the maintenance of the broaching machine or replacement of the external broach 10 is inconvenient in a limited operating space, so that the conventional external broach 10 and the fixing seat 15 have room for improvement.

Additionally, when the external broach 10 is fixed to the fixing seat 15, an axial surface 13 of the conventional external broach 10 is perpendicular to a top surface 152 of the fixing seat 15, as shown in FIG. 1. However, when the mouth C of an uncut wrench W aligned corresponding to the cutting portion 11 of the external broach 10 and the size of the uncut wrench W is long, a depth of a place platform of the conventional broaching machine needs to be increased, leading a volume of the broaching machine is increased. Besides, since the axial surface 13 of the conventional external broach 10 is perpendicular to the top surface 152 of the fixing seat 15, the wrench W will shake relative to an assembly of the external broach 10 and the fixing seat 15 during a cutting process, leading producing a defective product (namely, reducing a yield of production).

Besides, the broaching machine with the conventional external broach 10 and the fixing seat 15 could only cut one piece of wrench W once. It is unable to cut multiple pieces of wrenches W at the same time, so that the efficiency of the broaching machine is low.

To sum up, the conventional external broach 10 and the assembly of the fixing seat 15 and the external broach 10 have room for improvement

### BRIEF SUMMARY OF THE INVENTION

In view of the above, the primary objective of inventive subject matter is to provide a processing tool and a processing tool assembly, wherein the processing tool of the processing tool assembly could be changed easily to save operating time and space. Besides, the processing tool assembly could process multiple workpieces at the same time, thereby enhancing the efficiency of the process. Moreover, the processing tool and the processing tool assembly provided by the present invention adopting an inclining design, so that a depth of a placing platform does not need to be increased for fitting or completing a process to a workpiece with long size. On the other side, the processing tool and the processing tool assembly adopting the inclining design could prevent a wrench from being shaken relative to the processing tool and the processing tool assembly during processing, thereby enhancing a yield of processing.

The present invention provides a processing tool including a long cutting portion and at least one clamped portion, wherein the long cutting portion extends along a longitudinal direction and having a connecting surface. The at least one clamped portion is fixed to the connecting surface. Each of two ends of the long cutting portion along the longitudinal direction is an abutted end. A bottom portion of each of the abutted ends is connected to the connecting surface, and a top portion of each of the abutted ends is away from the connecting surface. A distance between the top portions of the abutted ends is a first length, and a distance between the bottom portions of the abutted ends is a second length, wherein the first length is shorter than the second length.

The inventive subject matter further provides a processing tool assembly including a substrate, a first clamping block set, a second clamping block set, a plurality of blocking set, and at least one of processing tool as mentioned above. The substrate includes at least one long groove which extends along a longitudinal direction and includes an inclined bottom. The first clamping block set is disposed on the inclined bottom of the at least one long groove and touches a first side of the at least one long groove. The second clamping block set is disposed on the inclined bottom of the at least one long groove and touches a second side of the at least one long groove. The plurality of blocking sets are disposed on the inclined bottom of the at least one long groove and is manipulatable to move along the longitudinal direction in the at least one long groove. The at least one processing tool is disposed in the at least one long groove and between the first clamping block set and the second clamping block set. The at least one clamped portion of the at least one processing tool is clamped between the first clamping block set and the second clamping block set, and each of the abutted ends of the long cutting portion is urged by one of the plurality of blocking sets, so that the at least one processing tool is fixed in the at least one long groove of the substrate and is unable to move relative to the substrate. The long cutting portion is defined to have an axial surface that passes through the top portions and the bottom portions of the abutted end and divides the long cutting portion into two parts with almost equal volume. An acute angle is formed between the axial surface of the long cutting portion and a top surface of the substrate.

With the aforementioned design, the processing tool disposed on the processing tool assembly could be changed easily, thereby reducing operating time and saving space that are needed for changing the processing tool. Besides, the multiple workpieces could be simultaneously cut by the processing tool assembly, thereby enhancing the efficiency of processing. Additionally, with inclining design, the workpiece could be placed inclinedly, so that additional depth does not need to be adopted to a placing platform to receive a workpiece with longer or greater size to complete a process of the workpiece with longer or greater size, thereby effectively reducing the volume of the broaching machine. Furthermore, the inclining design of the processing tool and the processing tool assembly could avoid the wrench being shaken relative to the processing tool and the processing tool assembly during the cutting process, thereby promoting the yield of the cutting-processed production.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a top view of the conventional external broach and the fixing seat thereof that is used for processing the wrench, showing the state of usage;

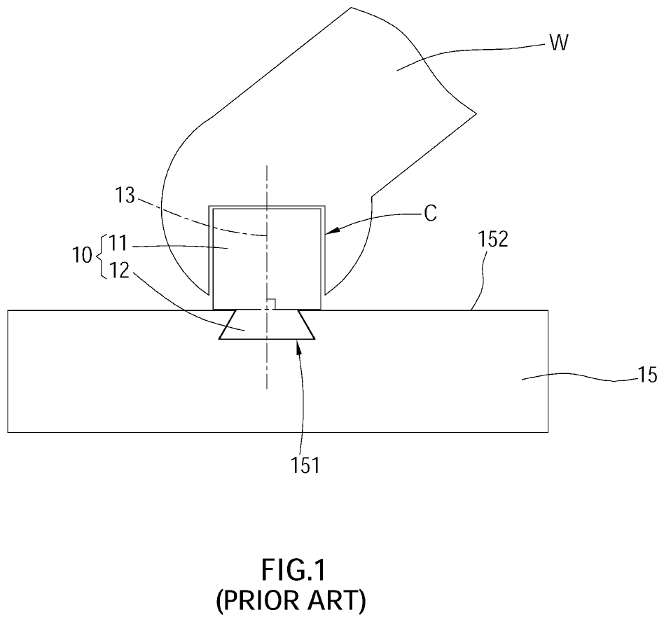

FIG. 2 is a perspective view of the processing tool of an embodiment according to the present invention;

FIG. 3 is a side view of the processing tool shown in FIG. 2;

FIG. 4 is an enlarged partial view of the processing tool of another embodiment according to the present invention;

FIG. 5A is a sectional view taken along the 5A-5A line in FIG. 3;

FIG. 5B is similar to FIG. 5A, showing a section view of the processing tool of another embodiment according to the present invention;

FIG. 5C is similar to FIG. 5A, showing a section view of the processing tool of another embodiment according to the present invention;

FIG. 6 is a perspective view of the processing tool assembly of an embodiment according to the present invention, wherein the processing tool assembly includes the processing tool of the embodiment mentioned above;

FIG. 7 is a front view of the processing tool assembly shown in FIG. 6;

FIG. 8 is a sectional view taken along the 8-8 line in FIG. 7:

FIG. 9 is a sectional view taken along the 9-9 line in FIG. 7; and

FIG. 10 is a top view of the processing tool assembly of the embodiment according to the present invention, showing the state of usage.

### DETAILED DESCRIPTION OF THE INVENTION

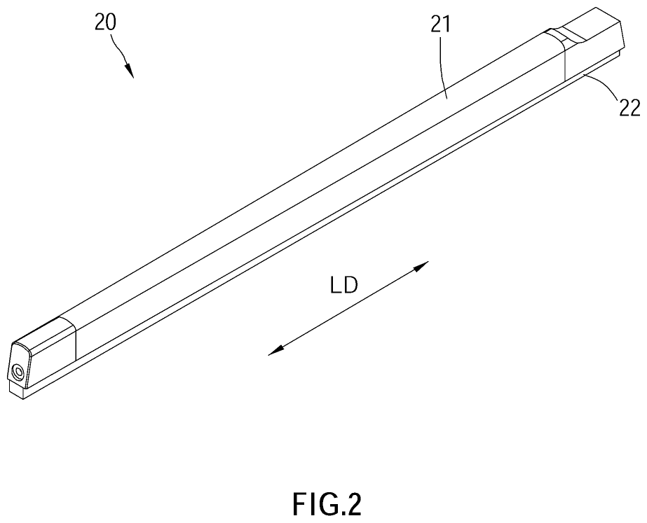

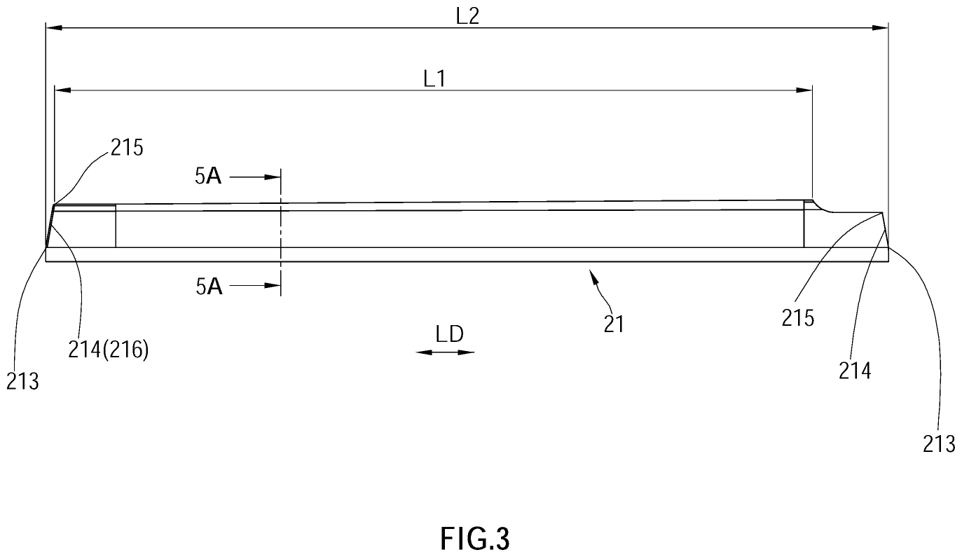

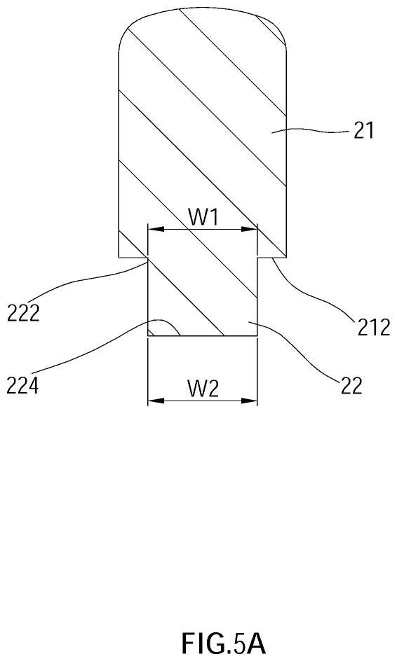

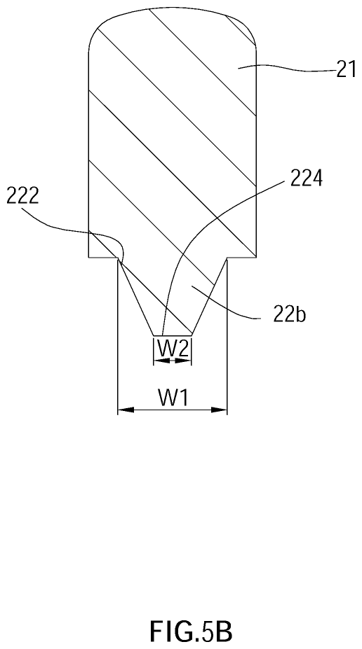

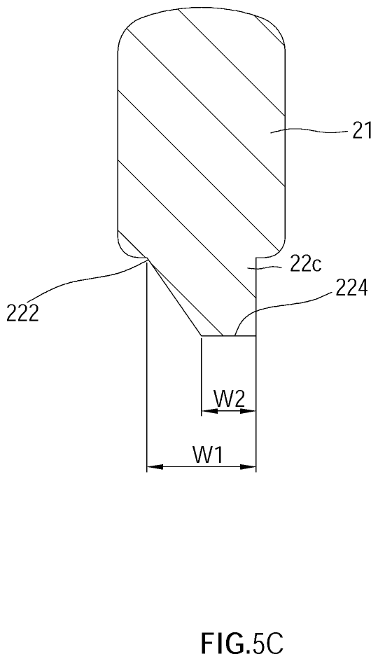

FIG. 2 to FIG. 5C illustrates a processing tool 20 of an embodiment according to the present invention, wherein FIG. 2 is a perspective view of the processing tool 20 of an embodiment according to the present invention; FIG. 3 is a top view of the processing tool 20 shown in FIG. 2; FIG. 5A is a sectional view taken along the 5A-5A line in FIG. 3; FIG. 5B is similar to FIG. 5A, showing a section view of the processing tool 20 of another embodiment according to the present invention; FIG. 5C is similar to FIG. 5A, showing a section view of the processing tool 20 of another embodiment according to the present invention;

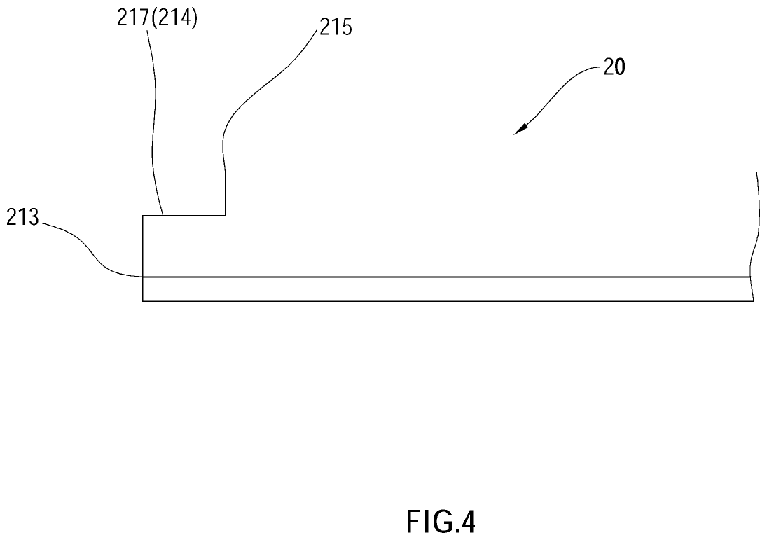

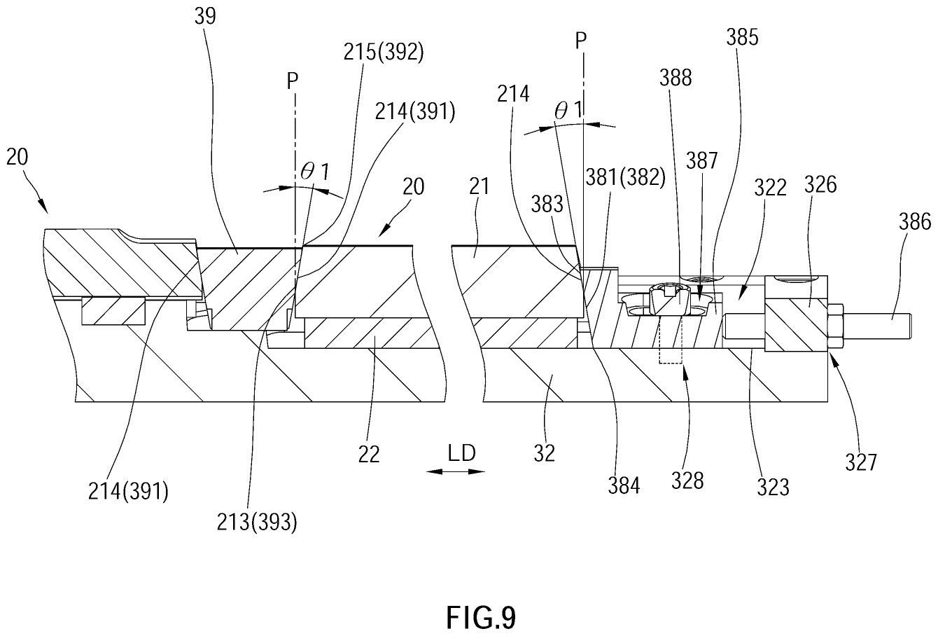

As illustrated in FIG. 2 to FIG. 4, the processing tool 20 of an embodiment according to the present invention includes a long cutting portion 21 and at least one clamped portion 22, wherein the long cutting portion 21 extends along a longitudinal direction LD and has a connecting surface 212. Each of two ends of the long cutting portion 21 along the longitudinal direction LD is an abutted end 214. A bottom portion 213 of each of the abutted ends 214 is connected to the connecting surface 212, and a top portion 215 of each of the abutted ends 214 is away from the connecting surface 212. A distance between the top portions 215 of the abutted ends 214 is a first length L1, and a distance between the bottom portions 213 of the abutted ends 214 is a second length L2. In the current embodiment, the first length L1 is shorter than the second length L2. In the current embodiment, each of the abutted ends 214 is an abutted incline 216, a step surface 217, or the combination thereof. When the abutted ends 214 are the abutted inclines 216, an included angle θ1 formed between each of the abutted inclines 216 and an imaginary plane P that is perpendicular to the longitudinal direction LD is in a range between 5 degrees and 15 degrees, as shown in FIG. 9. As illustrated in FIG. 4, in other embodiments, each of the abutted ends 214 could be the step surface 217.

As illustrated in FIG. 5A, the at least one clamped portion 22 includes a connecting end 222 and a free end 224. The connecting end 222 is fixed onto the connecting surface 212, and the free end 224 is away from the connecting surface 212. The connecting end 222 has a first width W1, and the free end 224 has a second width W2, wherein the first width W1 is wider than or equal to the second width W2. In another embodiment, as illustrated in FIG. 5B, at least one clamped portion 22b includes a connecting end 222 and a free end 224, wherein the connecting end 222 is fixed to the connecting surface 212, and the free end 224 is away from the connecting surface 212. The connecting end 222 has a first width W1, and the free end 224 has a second width W2, wherein the first width W1 is wider than the second width W2. Briefly speaking, the at least one clamped portion 22b is an inverted isosceles trapezoid. In another embodiment, as illustrated in FIG. 5C, at least one clamped portion 22c includes a connecting end 222 and a free end 224. The connecting end 222 is fixed to the connecting surface 212, and the free end 224 is away from the connecting surface 212. The connecting end 222 has a first width W1, and the free end 224 has a second width W2, wherein the first width W1 is wider than or equal to the second width W2. Briefly speaking, the at least one clamped portion 22c is an inverted right trapezoid.

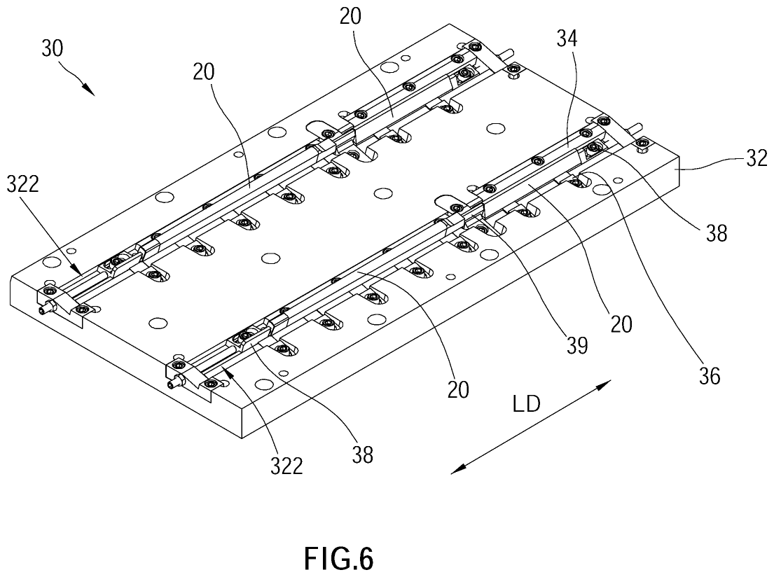

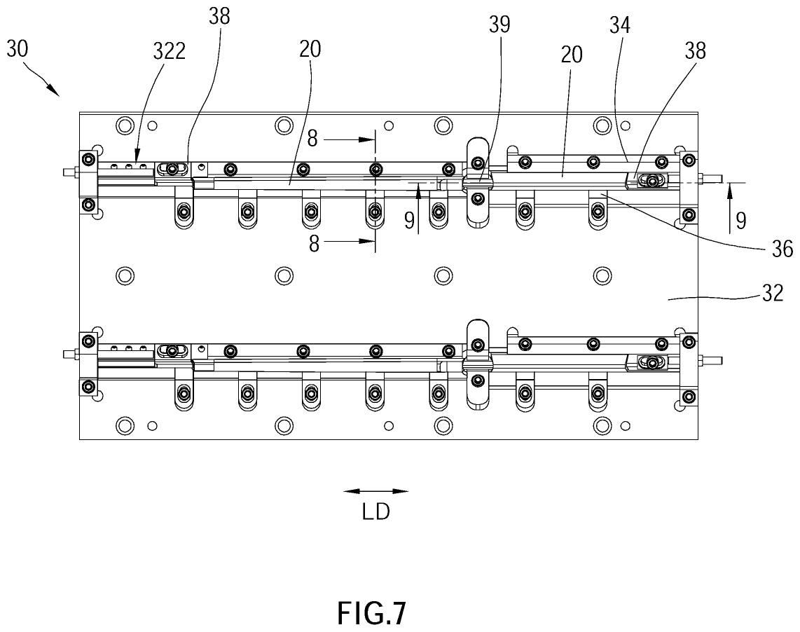

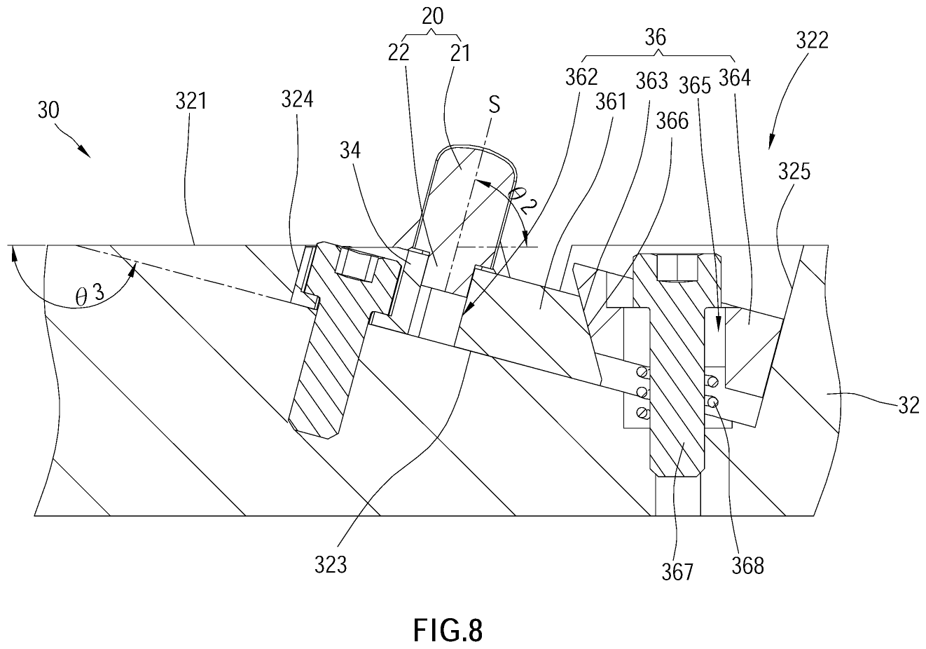

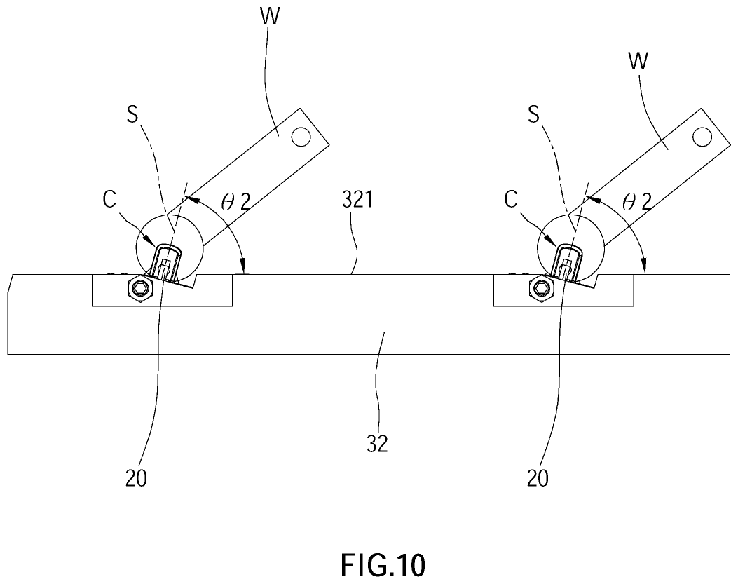

FIG. 6 to FIG. 10 illustrate a processing tool assembly 30 of an embodiment according to the present invention, wherein FIG. 6 is a perspective view of the processing tool assembly of an embodiment according to the present invention; FIG. 7 is a front view of the processing tool assembly shown in FIG. 6; FIG. 8 is a sectional view taken along the 8-8 line in FIG. 7; FIG. 9 is a sectional view taken along the 9-9 line in FIG. 7; FIG. 10 is a top view of the processing tool assembly of the embodiment according to the present invention, showing the state of usage. As illustrated in FIG. 6 to FIG. 10, the processing tool assembly 30 includes a substrate 32, a first clamping block set 34, a second clamping block set 36, and a plurality of blocking sets 38.

The substrate 32 includes at least one long groove 322 which extends along the longitudinal direction LD and includes an inclined bottom 323. The first clamping block set 34 is detachably disposed on the inclined bottom 323 of the at least one long groove 322 and touches a first side 324 of the at least one long groove 322. The second clamping block set 36 is detachably disposed on the inclined bottom 323 of the at least one long groove 322 and touches a second side 325 of the at least one long groove 322. The plurality of blocking set 38 is disposed on the inclined bottom 323 of the at least one long groove 322 and could be manipulated to move along the longitudinal direction LD in the at least one long groove 322.

At least one of the processing tools 20 of the above-mentioned embodiments is disposed in the at least one long groove 322 and is disposed between adjacent two of the plurality of blocking sets 38. The at least one clamped portion 22 of the at least one processing tool 20 is clamped between the first clamping block set 34 and the second clamping block set 36. Each of the abutted ends 214 of the long cutting portion 21 is urged by one of the plurality of blocking sets 38, so that the at least one processing tool 20 is fixed in the at least one long groove 322 of the substrate 32, thereby restricting the at least one processing tool 20 to move relative to the substrate 32. In the current embodiment, when the first clamping block set 34 and the second clamping block set 36 are loosened, the processing tool 20 could be removed from the long groove 322 along a direction that is perpendicular to the longitudinal direction LD. More precisely, the processing tool 20 could be removed from the long groove 322 along a direction that is perpendicular to the inclined bottom 323. With such design, the processing tool 20 could be changed easily, thereby reducing an operating time and saving a space that are needed for changing the processing tool 20.

The long cutting portion 21 is defined to have an axial surface S that passes through the top portions 215 and the bottom portions 213 of the abutted ends 214 and divides the long cutting portion 21 into two parts with almost equal volume. An acute angle θ2 is formed between the axial surface S of the long cutting portion 21 and a top surface 321 of the substrate 32. In the current embodiment, the acute angle θ2 formed between the axial surface S of the long cutting portion 21 and the top surface 321 of the substrate 32 is arranged from 45 degrees to 85 degrees. In an embodiment, the acute angle θ2 could be arranged from 55 degrees to 75 degrees. In another embodiment, the acute angle θ2 could be arranged from 50 degrees to 65 degrees. In the current embodiment, the axial surface S of the long cutting portion 21 is perpendicular to the inclined bottom 323 of the at least one long groove 322. It's worthy to mention that the processing tool 20 and the processing tool assembly 30 provided by the current embodiment of the present invention is adopted with an inclining design (namely, the processing tool 20 is tilted relative to the top surface 321 of the substrate 32), so that a workpiece (i.e. a wrench W) could be placed obliquely. With such design, additional depth does not need to be added to a placing platform to receive a workpiece with longer or greater size to complete a process of the workpiece with longer or greater size, so that a volume of a broaching machine could be effectively reduced. Moreover, the processing tool 20 and the processing tool assembly 30 provided by the current embodiment of the present invention is adopted with the inclining design, so that shake of the wrench W under processing relative to the processing tool 20 and the processing tool assembly 30 could be reduced, thereby promoting a yield of the cutting-processed production.

In the current embodiment, an included angle θ3 is formed between the inclined bottom 323 of the at least one long groove 322 and the top surface 321 of the substrate 32. The included angle θ3 is greater than the acute angle θ2 and is smaller than 180 degrees. In the current embodiment, the included angle θ3 is arranged from 135 degrees to 175 degrees. In an embodiment, the included angle θ3 is arranged from 145 degrees to 165 degrees. In another embodiment, the included angle θ3 is arranged from 150 degrees to 160 degrees.

As illustrated in FIG. 8, the second clamping block set 36 includes a first block 361, a second block 364, and a fastener 367, wherein the first block 361 has an abutting surface 362 and a first incline 363, and the second block 364 has a perforation 365 and a second incline 366. The abutting surface 362 of the first block 361 abuts against the at least one clamped portion 22 of the at least one processing tool 20. The second block 364 touches a second side 325 of the at least one long groove 322. The first incline 363 of the first block 361 contacts with the second incline 366 of the second block 364. The fastener 367 passes through the perforation 365 of the second block 364 and is screwed into the inclined bottom 323 of the at least one long groove 322.

When the fastener 367 is screwed toward the inclined bottom 323 of the at least one long groove 322 to drive the second block 364 to get close to the inclined bottom 323, the second incline 366 of the second block 364 urges against the first incline 363 of the first block 361 to make the first block 361 move in a direction toward the first clamping block set 34, so that the first clamping block set 34 and the first block 361 of the second clamping block set 36 jointly clamp the at least one clamped portion 22 of the at least one processing tool 20.

As illustrated in FIG. 8, the second clamping block set 36 includes an elastic member 368, wherein the elastic member 368 is disposed between the second block 364 and the inclined bottom 323 of the at least one long groove 322. Two ends of the elastic member 368 respectively touch with the second block 364 and the inclined bottom 323. When the fastener 367 is loosened in a direction away from the inclined bottom 323 of the at least one long groove 322, the elastic member 368 urges the second block 364 to move away from the inclined bottom 323. At this time, the second incline 366 of the second block 364 stops urging the first incline 363 of the first block 361, so that the first block 361 could be manipulated to freely move relative to the second block 364.

As illustrated in FIG. 9, each of the blocking sets 38 includes an urging end 381 which is complementary to one of the abutted ends 214 of the at least one processing tool 20. Each of the abutted ends 214 of the at least one processing tool 20 is the abutted incline 216, and the urging ends 381 of each of the blocking set 38 respectively include an urging incline 382, wherein the abutted incline 216 contacts with the urging incline 382. In the current embodiment, a top portion 383 of the urging end 381 protrudes over the bottom portion 384 of the urging end 381 in the longitudinal direction LD.

The substrate 32 has two blocking walls 326 which is respectively located at each of two ends of the at least one long groove 322, wherein each of the blocking walls 326 has a screw hole 327. Each of the blocking sets 38 includes a blocking member 385 and a screw rod 386, wherein the blocking member 385 includes the urging end 381 adapted to urge the abutted ends 214 of the at least one processing tool 20. The screw rod 386 is screwed into and passes through the screw hole 327, and an end of the screw rod 386 urges against the blocking member 385.

When the screw rod 386 is screwed in a direction toward the at least one long groove 322, the screw rod 386 urges the blocking member 385 to get close to the at least one processing tool 20, so that the urging end 381 of the blocking set 38 abuts against one of the abutted ends 214 of the at least one processing tool 20. On contrary, when the screw rod 386 is screwed in a direction away from the at least one long groove 322, the screw rod 386 stops urging against the blocking member 385, so that the blocking member 385 could move away from the at least one processing tool 20 to make the urging end 381 of the blocking set 38 not urge against the abutted end 214 of the at least one processing tool 20.

The blocking member 385 has a slot 387, wherein a longitudinal direction of the slot 387 is parallel to the longitudinal direction LD. The inclined bottom 323 of the at least one long groove 322 has a plurality of threaded hole 328. A fastener 388 passes through the slot 387 and is screwed into one of the plurality of threaded holes 328, so that the blocking member 385 is restricted by the fastener 388 to be operated to move along the longitudinal direction LD within a length between two ends of the slot 387.

Additionally, as illustrated in FIG. 9, the processing tool assembly 30 includes at least one intermediate block 39 fixed on the inclined bottom 323 of the at least one long groove 322. When an amount of the at least one processing tool 20 is plural, the at least one intermediate block 39 is clamped between two of the processing tools 20. Each of the abutted ends 214 of the at least one processing tool 20 is an abutted incline 216. Two sides of the at least one intermediate block 39 along the longitudinal direction LD respectively include an abutted incline 216, wherein the abutted incline 216 and the urging incline 391 are abutted to each other. In the current embodiment, top portions 392 of the two sides of the at least one intermediate block 39 protrude over bottom portions 393 of the two sides of the at least one intermediate block 39 in the longitudinal direction LD. In an embodiment, the processing tools 20 could be tools with the same specs or different specs, so that the single processing tool assembly 30 can perform mass production or a variety of processes, thereby enhancing the efficiency of the process.

As illustrated in FIG. 10, the substrate 32 includes two long grooves 322, and the plurality of processing tools 20 could be respectively disposed in the two long grooves 322, so that it is possible to simultaneously cut a mouth C for each of two wrenches W in a single operation of a broaching machine. In practice, the substrate 32 could include three or more long grooves 322 for mounting more processing tools 20, so that a amount of cutting processed wrench W produced in each operation could be increased. Namely, the efficiency of the cutting process of the wrench is enhanced.

With the processing tool and the processing tool assembly provided in the present invention, the processing tools could be changed easily, thereby reducing operating time and saving space that are needed for changing the processing tool. Additionally, the inclining design of the processing tool and the processing tool assembly allows the workpiece to be placed inclinedly, so that additional depth does not need to be adopted to a placing platform to receive a workpiece with longer or greater size to complete a process of the workpiece with longer or greater size, thereby effectively reducing the volume of the broaching machine. Moreover, the inclining design of the processing tool and the processing tool assembly could avoid the wrench being shaken relative to the processing tool and the processing tool assembly during the cutting process, thereby promoting the yield of the cutting-processed production.

It must be pointed out that the embodiment described above is only a preferred embodiment of the present invention. All equivalent structures which employ the concepts disclosed in this specification and the appended claims should fall within the scope of the present invention.

What is claimed is:

1. A processing tool comprising:
a long cutting portion extending along a longitudinal direction and having a connecting surface;
at least one clamped portion fixed to the connecting surface;
wherein, each of two ends of the long cutting portion along the longitudinal direction is an abutted end; a bottom portion of each of the abutted ends is connected to the connecting surface, and a top portion of each of the abutted ends is away from the connecting surface; a distance between the top portions of the abutted ends is a first length, and a distance between the bottom portions of the abutted ends is a second length, wherein the first length is shorter than the second length.

2. The processing tool as claimed in claim 1, wherein the at least one clamped portion comprises a connecting end and a free end; the connecting end is fixed to the connecting surface, and the free end is away from the connecting surface; the connecting end has a first width, and the free end has a second width, wherein the first width is wider than or equal to the second width.

3. The processing tool as claimed in claim 1, wherein each of the abutted ends is an abutted incline, a step surface, or a combination thereof.

4. The processing tool as claimed in claim 3, wherein the abutted ends are the abutted inclines; an included angle formed between each of the abutted inclines and an imaginary plane that is perpendicular to the longitudinal direction is from 5 degrees to 15 degrees.

5. A processing tool assembly comprising:
a substrate comprising at least one long groove which extends along a longitudinal direction and comprises an inclined bottom;
a first clamping block set disposed on the inclined bottom of the at least one long groove and touches a first side of the at least one long groove;
a second clamping block set disposed on the inclined bottom of the at least one long groove and touches a second side of the at least one long groove;
a plurality of blocking sets disposed on the inclined bottom of the at least one long groove and being manipulatable to move along the longitudinal direction in the at least one long groove; and
at least one processing tool as claimed in claim 1 disposed in the at least one long groove and between the first clamping block set and the second clamping block set; the at least one clamped portion of the at least one processing tool is clamped between the first clamping block set and the second clamping block set, and each of the abutted ends of the long cutting portion is urged by one of the plurality of blocking sets, so that the at least one processing tool is fixed in the at least one long groove of the substrate and is unable to move relative to the substrate; the long cutting portion is defined to have an axial surface that passes through the top portions and the bottom portions of the abutted end and divides the long cutting portion into two parts with almost equal volume; an acute angle is formed between the axial surface of the long cutting portion and a top surface of the substrate.

6. The processing tool assembly as claimed in claim 5, wherein the acute angle formed between the axial surface of the long cutting portion and the top surface of the substrate is from 45 degrees to 85 degrees.

7. The processing tool assembly as claimed in claim 5, wherein the axial surface of the long cutting portion is perpendicular to the inclined bottom of the at least one long groove.

8. The processing tool assembly as claimed in claim 7, wherein an included angle is formed between the inclined bottom of the at least one long groove and the top surface of the substrate, wherein the included angle is greater than the acute angle, but smaller than 180 degrees.

9. The processing tool assembly as claimed in claim 5, wherein the second clamping block set comprises a first block, a second block, and a fastener; the first block has an abutting surface and a first incline, and the second block has a perforation and a second incline; the abutting surface of the first block abuts against the at least one clamped portion of the at least one processing tool; the second block touches the second side of the at least one long groove; the first incline of the first block contacts with the second incline of the second block, the fastener passes through the perforation of the second block to be screwed into the inclined bottom of the at least one long groove; when the fastener is screwed into the inclined bottom of the at least one long groove to drive the second block to get close to the inclined bottom, the second incline of the second block urges against the first incline of the first block to make the first block move in a direction toward the first clamping block set, so that the first clamping block set and the first block of the second clamping block set jointly clamp the at least one clamped portion of the at least one processing tool.

10. The processing tool assembly as claimed in claim 9, wherein the second clamping block set comprises an elastic member which is disposed between the second block and the inclined bottom of the at least one long groove, wherein two ends of the elastic member respectively touch with the second block and the inclined bottom; when the fastener is loosened in a direction away from the inclined bottom of the at least one long groove to make the elastic member urge the second block to move away from the inclined bottom, the second incline of the second block stops urging the first incline of the first block, so that the first block is manipulatable to freely move.

11. The processing tool assembly as claimed in claim 5, wherein each of the blocking sets comprises an urging end which is complementary to one of the abutted ends of the at least one processing tool; each of the abutted ends of the at least one processing tool is an abutted incline, and the urging end of each of the blocking set comprises an urging incline, wherein the abutted incline contacts with the urging incline.

12. The processing tool assembly as claimed in claim 11, wherein a top portion of the urging end protrudes over a bottom portion of the urging end in the longitudinal direction.

13. The processing tool assembly as claimed in claim 11, wherein the substrate has two blocking walls which are respectively located at each of two ends of the at least one long groove, and each of the blocking walls has a screw hole; each of the blocking sets comprises a blocking member and a screw rod, wherein the blocking member comprises the urging end adapted to urge one of the abutted ends of the at least one processing tool; the screw rod is screwed into and passes through the screw hole, and an end of the screw rod urges against the blocking member to move the blocking member get close to the at least one processing tool, so that the urging end of the blocking set abuts against one of the abutted ends of the at least one processing tool.

14. The processing tool assembly as claimed in claim 13, wherein the blocking member has a slot, and a longitudinal direction of the slot is parallel to the longitudinal direction; the inclined bottom of the at least one long groove has a plurality of threaded holes; a fastener passes through the slot and is screwed into one of the plurality of threaded holes to restrict the blocking member; with the restriction of the fastener, the blocking member is operatable to move along the longitudinal direction within a length between two ends of the slot.

15. The processing tool assembly as claimed in claim 5, further comprising at least one intermediate block fixed on the inclined bottom of the at least one long groove, wherein when an amount of the at least one processing tool is plural, the at least one intermediate block is clamped between two of the processing tools.

16. The processing tool assembly as claimed in claim 15, wherein each of the abutted ends of each of the processing tools is an abutted incline, two sides of the at least one intermediate block along the longitudinal direction respectively comprise an urging incline, wherein the abutted incline and the urging incline are abutted to each other.

17. The processing tool assembly as claimed in claim 16, wherein top portions of the two sides of the at least one intermediate block protrude over bottom portions of the two sides of the at least one intermediate block in the longitudinal direction.
